(19) United States
(12) Patent Application Publication
(10) Pub. No.: US 2019/0012894 A1
(43) Pub. Date: Jan. 10, 2019

(54) Electronic Fall Event Communication System

(71) Applicant: 3M INNOVATIVE PROPERTIES COMPANY, St Paul, MN (US)

(72) Inventor: Judd J. Perner, East Dubuque, IL (US)

(73) Assignee: 3M INNOVATIVE PROPERTIES COMPANY, St. Paul, MN (US)

(21) Appl. No.: 16/066,372

(22) PCT Filed: Jul. 12, 2016
(86) PCT No.: PCT/US2016/041830

§ 371 Date: Jun. 27, 2018

Related U.S. Application Data
(60) Provisional application No. 62/273,049, filed on Dec. 30, 2015.

(51) Int. Cl. G08B 21/04; G08B 25/08

(52) U.S. Cl. CPC G08B 21/043; G08B 25/08; G08B 21/0446

(57) ABSTRACT

The fall event detection and communication system includes at least one fall detect node and a personal communication application. The at least one fall detect node is to be implemented as part of a fall protection system. The at least one fall detect node includes at least one detection element and a node transmitter. The at least one detection element is to generate an activation signal upon a condition that indicates a fall event has occurred. The node transmitter is to transmit at least one fall detect signal upon receiving the activation signal from the at least one detection element. The personal communication application is stored in a personal communication device. The personal communication application is to cause the personal communication device to monitor for the fall detect signal and cause the personal communication device to communicate with a remote communication device upon determination that a fall event has occurred.

### BACKGROUND

Fall protection is critical for occupational health and safety of workers required to work at heights. Unlike other types of hazards a worker is exposed to such as electrical or mechanical hazards, gravitational potential energy is a universal hazard that affects every organization that requires work done at heights. To combat the dangers associated with working at heights, fall protection equipment manufacturers have developed devices to safely arrest a fall of a worker during a fall event. Although these devices generally perform as intended and safely arrest a worker's fall, there is still potential for harm to come to the worker if the worker is not rescued in a timely manner. This situation is especially relevant when the worker is working alone in a remote location.

For the reasons stated above and for other reasons stated below which will become apparent to those skilled in the art upon reading and understanding the present specification, there is a need in the art for an effective and efficient way to communicate a fall event to a third party.

### SUMMARY OF INVENTION

The above-mentioned problems of current systems are addressed by embodiments of the present disclosure and will be understood by reading and studying the following specification. The following summary is made by way of example and not by way of limitation. It is merely provided to aid the reader in understanding some of the aspects of the disclosure.

In one embodiment, a fall event detection and communication system is provided. The fall event detection and communication system includes at least one fall detect node and a personal communication application. The at least one fall detect node is to be implemented as part of a fall protection system. The at least one fall detect node includes at least one detection element and a node transmitter. The at least one detection element is to generate an activation signal upon a condition that indicates a fall event has occurred. The node transmitter is to transmit at least one fall detect signal upon receiving the activation signal from the at least one detection element. The personal communication application is stored in a personal communication device. The personal communication application is to cause the personal communication device to monitor for the fall detect signal from the node transmitter of the at least one fall detect node. The personal communication application is further to cause the personal communication device to determine if a fall event has occurred based at least in part on receiving the at least one fall detect signal from the at least one fall detect node. The personal communication application is further yet to cause the personal communication device to communicate with a remote communication device upon determination that a fall event has occurred.

In another embodiment, a fall detect node is provided. The fall detect node includes an at least one detection element and a transmitter. The at least one detection element is implemented with a fall protection system. The detection element is to detect a fall event. The transmitter is in communication with the at least one detection element. The transmitter is further to send a fall detect signal to a personal communication device upon the detection of a fall event by the at least one detection element.

In yet another embodiment, a method of communicating a fall event to a remote communication device is provided. The method includes generating a fall detect signal with at least one fall detect node that is implemented in a fall protection system when a fall event is detected. The at least one fall detect node is monitored for the fall detect signal with a personal communication device. A fall alarm message is generated with the personal communication device based at least in part on a detected fall detect signal from the at least one fall detect node.

### BRIEF DESCRIPTION OF THE DRAWINGS

The present disclosure can be more easily understood and further advantages and uses thereof will be more readily apparent, when considered in view of the detailed description and the following figures in which:

FIG. 1 is a block diagram of a fall event detection and communication system;

FIG. 2 is an application flow diagram of one embodiment of the present disclosure; and

FIG. 3 is an application flow diagram for another embodiment of the present disclosure.

In accordance with common practice, the various described features are not drawn to scale but are drawn to emphasize specific features relevant to the present disclosure. Reference characters denote like elements throughout Figures and text.

### DETAILED DESCRIPTION

In the following detailed description, reference is made to the accompanying drawings, which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the spirit and scope of the present disclosure. The following detailed description is, therefore, not to be taken in a limiting sense, and the scope of the present disclosure is defined only by the claims and equivalents thereof.

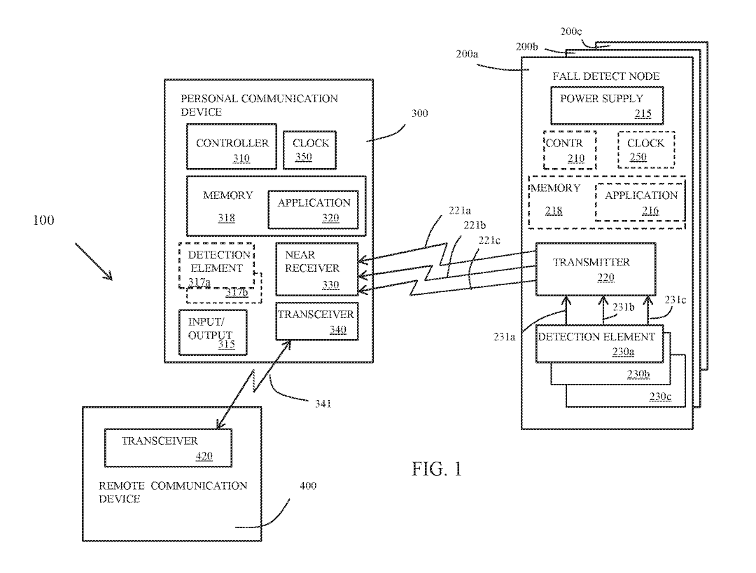

Embodiments of the present disclosure provide a fall event detection and communication system. An example of a fall event detection and communication system 100 is illustrated in FIG. 1. The fall event detection and communication system 100 in this embodiment includes at least one fall detect node 200a, 200b or 200c, a personal communication device 300 and a remote communication device 400. Each fall detect node 200a, 200b and 200c in this embodiment includes a least one detection element 230a, 230b or 230c, a transmitter 220 and a power supply 215. The fall detect nodes 200a, 200b and 200c are implemented as part of a fall protection system that is used by a user while working at heights. Examples of the implementation of at least one fall detect node 200a, 200b or 200c are described below.

As discussed above, the fall detect node 200a, 200b or 200c, in the embodiment of FIG. 1 includes at least one detection element 230a, 230b or 230c, a transmitter 220 and a power supply 215. The at least one of the detection elements 230a, 230b or 230c is used to detect a fall event. Each detection element 230a, 230b and 230c is in communication with the transmitter 220. Examples of detection elements 230a, 230b and 230c include, but are not limited to, switches or sensors that detect conditions that indicate a fall event has occurred. For example, in one embodiment, one of the detection elements 230a, 230b or 230c is a pressure switch such as a spring loaded switch that is activated when a select weight is applied. In another embodiment, one of the detection elements 230a, 230b or 230c is an accelerometer sensor. Once at least one of the detection elements 230a, 230b or 230c detects a fall event, a respective activation signal 231a, 231b and 231c is sent to the transmitter 220. Upon receiving the activation signal, the transmitter 220 of the respective fall detect node 200a, 200b or 200c, powered by the power supply 215, transmits a fall detect signal 221a, 221b or 221c. In one embodiment, the fall detect signal 221a, 221b and 221c is a short range communication signal, such as but not limited to, a Bluetooth signal. A Bluetooth signal is a wireless signal using a Bluetooth wireless technology standard for exchanging data over short distances. The Bluetooth standard uses short-wavelength UHF radio waves.

In an alternative embodiment, at least one of the fall detect nodes 200a, 200b or 200c further includes a node memory 218 in which a node application 216 is stored. This embodiment also includes a node controller 210 to implement the node application 216 and a node clock 250. In an embodiment, the node controller 210 using instructions stored in the application 216 controls the transmitter 220 to transmit the fall detect signal 221a, 221b or 221c only after a select period of time has passed, determined with the use of the clock 250, in which one of the detection elements 230a, 230b or 230c has continuously detected a fall event. Although only three fall detection nodes 200a, 200b and 200c and three detection elements 230a, 230b and 230c per each fall detection node 200a, 200b and 200c is illustrated in FIG. 1, any number of fall detection nodes having at least one detection element could be used and the present disclosure is not limited to only three fall detection nodes 200a, 200b and 200c and three detection elements 230a, 230b and 230c per each fall detection node 200a, 200b and 200c.

The personal communication device 300 includes a near receiver 330 to receive the fall detect signal from the transmitter 220 of the fall detect node 200a, 200b and 200c. In one embodiment, the personal communication device 300 is a cellular phone. However, any type of personal communication device that can receive the fall detect signal can be used. For example, with the Bluetooth standard being used as the near communication standard, a cell phone with a receiver that communicates with the Bluetooth standard can be used. The personal communication device 300 in the embodiment of FIG. 1 also includes a personal communication controller 310 such as a processor, a personal communication clock 350, an input/output 315, a personal communication memory 318 and a transceiver 340.

The personal communication controller 310 controls operation of the personal communication device. Instructions implemented by the personal communication controller 310 to operate the personal communication device 300 are stored in the memory 318. Also illustrated in FIG. 1 in the personal communication device 300 is a personal communication application 320 that is also stored in the personal communication memory 318. The personal communication application 320 is a specific set of instructions implemented by the personal communication controller 310 for a specific purpose as described below. The personal communication controller 310 implements the application instructions when the application is activated by the user through the input/output 315 of the device 300. The personal communication clock 350 in this embodiment is used, among other reasons, to count the time the personal communication device 300 is receiving a fall detect signal 221a, 221b or 221c from the fall detect node 200a, 200b or 200c.

The transceiver 340 is used by the personal communication device 300 to send and receive signals over long distances. In the cellular phone example, the transceiver 340 would send and receive signals over a cellular network to a remote communication device 400. The remote communication device 400 could be another cell phone or land line that is located remote to the personal communication device 300. Through the personal communication transceiver 340 of the personal communication device 300, a fall alarm message 341 is sent to a remote transceiver 420 of the remote communication device 400 in embodiments. Moreover, in one embodiment, the personnel communication device 300 includes one or more detection elements 317a and 317b. Similar to the detection elements 230a, 230b and 230c in the fall detection node 200a, 200b and 200c, detection elements 317a and 317b can be used to detect fall events. An example of a detection element 317a and 317b is an accelerometer. However, other types of detection elements can be used in the personal communication device.

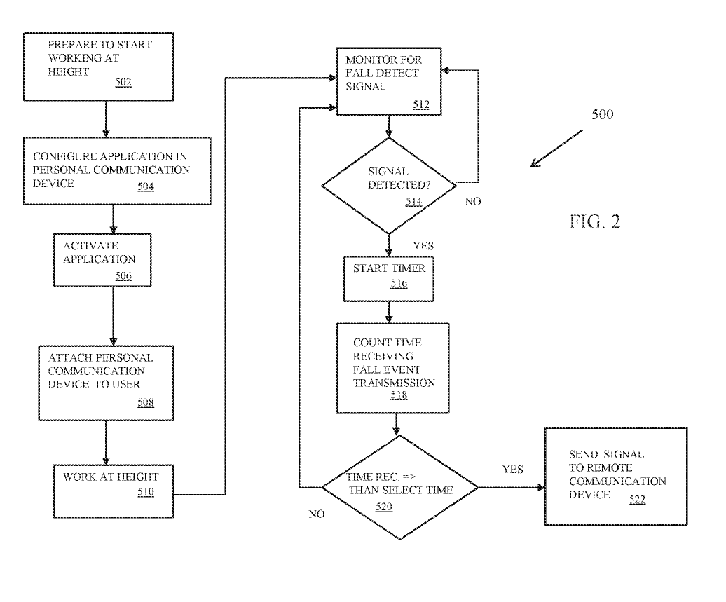

Referring to FIG. 2, an application flow diagram 500 of one embodiment is illustrated. The process starts by the user getting prepared for working at a height (502). In one embodiment, this would include implementing a fall protection system. For example, implementing fall protection system may include donning a safety harness and configuring the application 320 in the personal communication device 300 (504). The configuration may include providing a communication number to call if a fall event is detected, how long a fall detect signal 221a, 221b or 221c needs to be observed from the fall detect node 200a, 200b or 200c before a fall alarm message 341 is sent to the remote communication device 400, the type of fall alarm message 341 to send and content of the fall alarm message 341, etc. Once the application 320 is configured (504), the application 320 is activated on the personal communication device 300 (506). The personal communication device is then attached to the user who is going to be working at heights (508). The user then works at heights (510).

While the user is working at heights, the personal communication device 300 monitors for a fall detect signal 221a, 221b or 221c (512) pursuant to the directions set out by the application 320. If no fall detect signal 221a, 221b or 221c is detected (514), the process continues at (512). If a fall detect signal 221a, 221b or 221c is detected (514), in one embedment, the controller 310 of the personal communication device 300 starts a timer (516) (tracks time using the clock 350) pursuant to the instructions of the application 320. The controller 310 counts the time the near receiver 330 in this embodiment is receiving the fall detect signal 221a, 221b or 221c (518). If the continuous time receiving a fall detect signal 221a, 221b and 221c is less than the time configured in the application (520), the process continues back at (512) monitoring for a fall detect signal 221a, 221b or 221c. If the continuous time receiving fall detect signal 221a, 221c or 221c is equal or greater than the time configured in the application (520), the controller 310 of the personal communication device 300 activates the transceiver 340 to send a fall alarm message 341 to the remote communication device 400 (522).

Based on the received fall alarm message 341, rescue personal will be sent to rescue the fallen user. An example of a period of time configured in the application is a time that is more than 10 seconds and an example of a weight used by a fall detect node 200a, 200b or 200c to send the fall detect signal 221a, 221b or 221c is 130 lbs or more. In another embodiment, as discussed above, at least one of the fall detect nodes 200a, 200b or 200c is equipped to determine the continuous time its respective detection element 230a, 230b or 230c has detected a fall event. In this embodiment, a respective fall detect signal 221a, 221b or 221c will only be sent after the period of time has been confirmed. Further in this embodiment, the controller 310 of the personal communication device, pursuant to the instructions stored in the application 320, sends the fall alarm message 341 as soon as the respective fall detect signal 221a, 221b or 221c is detected.

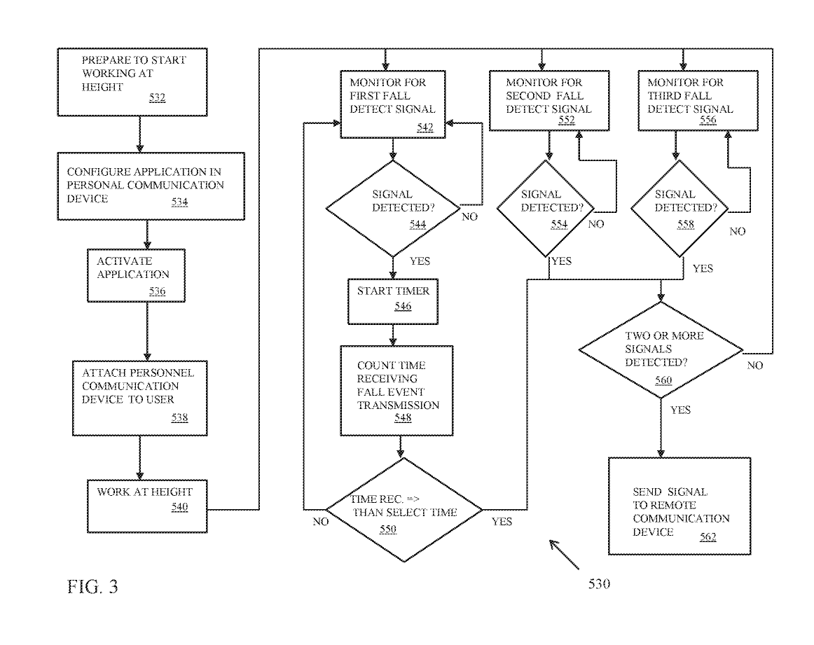

FIG. 3 illustrates an application flow diagram 530 of another embodiment. In this embodiment, at least two different detection elements are used when initiating a fall alarm message 341. For example, the at least two different detection elements may be selected among detection elements 230a, 230b, 230c, 317a and 317b. The process starts by the user getting prepared for working at a height (532). In one embodiment this would be done by implementing a fall protection system. Implementing the fall protection system may include donning a safety harness and configuring the application 320 in the personal communication device 300 (534). The configuration may include providing a communication number to call if a fall event is detected, the number of different signals from different detection elements 230a, 230b, 230c, 317a, 317b that are needed for a determination and verification of a fall event, how long a fall detect signal 221a, 221b and 221c needs to be observed from a detection element 230a, 230b, 230c, 317a and 317b before a fall alarm message 341 is sent to the remote communication device 400, type of fall alarm message 341 to send and content of fall alarm message 341, etc. Once the application 320 is configured (534), the application 320 is activated on the personal communication device 300 (536). The personal communication device is then attached to the user who is going to be working at heights (538). The user then works at heights (540).

While the user is working at heights, the personal communication device 300 monitors for fall detect signals (542), (552) and (556) pursuant to instructions set out by the application 320. The fall detect signals could be fall detect signals 221a, 221b, 221c. Moreover, the fall detect signals may come from detection elements 317a and 317b. Although the application flow diagram 530 indicates three different types of fall detect signals as used in this example, such as fall detect signals 221a, 221b and 221c from three different detection elements 230a, 230b and 230c, any number of different types of detection elements can be used.

In the application flow diagram 530 of FIG. 3, a personal communication device 300 monitors for a first fall detect signal, such as fall detect signal 221a from the first detection element 230a. In this embodiment, when a first fall detect signal 221a is detected (544), a timer is started (546). The controller 310 counts the time the near receiver 330 in this embodiment is receiving the fall detect signal 221a (548). If the continuous time receiving the fall detect signal 221a is less than the time configured in the application (550), the process continues back at (542) monitoring for the fall detect signal 221a. If the continuous time receiving the fall detect signal 221a is equal or greater than the time configured in the application (550), the controller 310 in this embodiment confirms if at least one other fall detect signal has been detected (560). For example, communication device 300 monitors for a second fall detect signal, such as fall detect signal 231b from the second detection element 230b at (552) and a third fall detect signal, such as fall detect signal 231c from the third detection element 230c at (556).

As stated above, in this embodiment, if two or more fall detect signals 221a, 221b and 221c are detected (544), (554) and (558), the fall alarm message 341 is sent to the remote communication device 400 (562). Hence, this embodiment allows for the confirmation of a fall event by requiring at least two independent fall detect systems to detect a fall event simultaneously. This cuts down on false fall detection events. For example, one detection element 230a may be a sensor that measures a load, while detection element 230b is a switch that is activated when a certain amount of force is applied and detection element 230c may be an accelerometer. Moreover, as discussed above, the personal communication device may include detection elements 317a and 317b (such as, but not limited to, accelerometer and/or decelerometer) that can also be used alone or in conjunction with detection elements 230a, 230b and 230c in the fall detect node 200a, 200b and 200c to detect and confirm fall events. Moreover, in another embodiment, at least one fall detect node 200a, 200b or 200c is equipped to count periods of time a fall event is detected by a detection element 230a, 230b, and 230c. In this embodiment, the personal communication controller 310 is configured to recognize that a fall event has been detected as soon as a fall detect signal 221a, 221b or 221c from the respective at least one node 200a, 200b and 200c is detected. The controller 310 in this embodiment would wait for at least one other fall detect signal for verification until a fall alarm message is sent.

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present disclosure. Therefore, it is manifestly intended that this disclosure be limited only by the claims and the equivalents thereof.

1. A fall event detection and communication system comprising:
at least one fall detect node to be implemented as part of a fall protection system, the at least one fall detect node including,
at least one detection element to generate an activation signal upon a condition that indicates a fall event has occurred, and
a node transmitter to transmit at least one fall detect signal upon receiving the activation signal from the at least one detection element; and
a personal communication application stored in a personal communication device, the personal communication application to cause the personal communication device to monitor for the fall detect signal from the node transmitter of the at least one fall detect node, the personal communication application further to cause the personal communication device to determine if a fall event has occurred based at least in part on receiving the at least one fall detect signal from the at least one fall detect node, the personal communication application further yet to cause the personal communication device to communicate with a remote communication device upon determination that a fall event has occurred.

2. The fall event detection and communication system of claim 1, wherein the at least one detection element is a switch that is to be activated when a load over a select weight is encountered by at least one component of the fall protection system.

3. The fall event detection and communication system of claim 1, wherein the at least one detection element is at least one of a switch and a sensor.

4. The fall event detection and communication system of claim 1, wherein the personal communication application is to cause the personal communication device to send the fall alarm message only after the fall detect signal has been received continuously for more than a select amount of time.

5. The fall event detection and communication system of claim 1, wherein at least one fall detect node is to only transmit the at least one fall detect signal upon receiving the activation signal from the at least one detection element for a select period of time.

6. The fall event detection and communication system of claim 5, wherein the at least one fall detect node further includes:
a node clock;
a node memory to store an application; and
a node controller to implement instructions in a node application, the instructions including instructing the node controller to time activation signals from the at least one detection element using the node clock.

7. The fall event detection and communication system of claim 1, wherein the personal communication application is to cause the personal communication device to send the fall alarm message only after two or more fall detect signals have been received.

8. The fall event detection and communication system of claim 1, wherein the fall detect signal is a short range communication signal.

9. The fall event detection and communication system of claim 1, wherein the personal communication device communicates with the remote communication device via a wireless telephone system.

10. A fall detect node comprising:
at least one detection element implemented with a fall protection system, the detection element to detect a fall event; and
a transmitter in communication with the at least one detection element, the transmitter to send a fall detect signal to a personal communication device upon the detection of a fall event by the at least one detection element.

11. The fall detect node of claim 10, further comprising:
the at least one detection element being a switch that is integrated in the fall protection system, the switch to be activated when a load over a selected weight is encountered by the fall protection harness; and
the transmitter to continuously send the fall detect signal to the personal communication device while the switch is activated.

12. The fall detect node of claim 11, wherein the switch is a spring loaded switch.

13. The fall detect node of claim 10, further comprising:
a power source to power the transmitter.

14. The fall detect node of claim 10, further comprising:
a node clock;
a node memory to store a node application; and
a controller to implement instructions in the node application, the instructions including instructing the node controller to time activation signals from the at least one detection element using the clock.

15. A method of communicating a fall event to a remote communication device, the method comprising:
generating a fall detect signal with at least one fall detect node that is implemented in a fall protection system when a fall event is detected;
monitoring the at least one fall detect node for the fall detect signal with a personal communication device; and
generating a fall alarm message with the personal communication device based at least in part on a detected fall detect signal from the at least one fall detect node.

16. The method of claim 15, further comprising:
tracking the amount of time the fall protection signal is generated by the at least one fall detect node;
when the amount of time tracked is over a select amount of time, transmitting the fall alarm message to a remote communication device.

17. The method of claim 15, wherein generating a fall detect signal with at least one fall detect node that is implemented in a fall protection system when a fall event is detected further comprises;
activating a spring loaded switch integrated in the fall protection system when a load on the fall protection system is over a select load; and
in response to the activation of the spring loaded switch, transmitting the fall detect signal to a personal communication device.

18. The method of claim 17, further comprising:
setting a select period of time the spring loaded activation switch has to be activated before transmitting the fall alarm message.

19. The method of claim 15, further comprising:
confirming a fall event with at least two detection elements before transmitting the fall alarm message.

20. The method of claim 19, wherein at least one of the at least two detection elements is part of the at least one fall detect node.
